(19) United States
(12) Patent Application Publication
(10) Pub. No.: US 2026/0223078 A1
(43) Pub. Date: Jul. 30, 2026

(54) PHASE TRACKING REFERENCE SIGNAL RESOURCE SELECTION

(71) Applicant: QUALCOMM Incorporated, San Diego, CA (US)

(72) Inventors: Amit MOSES, Tel Aviv (IL); Ronen SHAKED, Kfar Saba (IL); Aviv REGEV, Tel Aviv (IL)

(21) Appl. No.: 19/040,615

(22) Filed: Jan. 29, 2025

(51) Int. Cl. H04W 72/04; H04L 5/00

(52) U.S. Cl. CPC H04W 72/04; H04L 5/0051

(57) ABSTRACT

Various aspects of the present disclosure generally relate to wireless communication. Some aspects more specifically relate to dynamically selecting frequency resources to convey a phase tracking reference signal (PTRS). In some aspects, a network node may identify that a user equipment (UE) supports a PTRS that is contiguous over time resources and frequency resources. The network node may inform the UE of possible frequency resources for PTRS allocation. The UE may identify a frequency resource, from among the possible frequency resources, having a corresponding channel that can best support PTRS transmission. The UE may report the frequency resource to the network node, and the network node may transmit the PTRS, such as a contiguous PTRS, in accordance with the reported frequency resource.

### FIELD OF THE DISCLOSURE

Aspects of the present disclosure generally relate to wireless communication and specifically relate to techniques, apparatuses, and methods associated with phase tracking reference signal resource selection.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples.

Phase noise is a significant radio frequency (RF) impairment caused by random imperfections in oscillators. In some examples, a user equipment (UE) may be unable to cancel phase noise with sufficient accuracy that enables high-order modulations. For example, canceling the phase noise in accordance with a phase noise estimation using a phase tracking reference signal (PTRS) may not enable high-order modulations due to variable and/or poor channel conditions of the channel that conveys the PTRS. Thus, a UE operating at a high-order modulation suffers from a low signal-to-noise ratio (SNR) of the PTRS that may prevent the UE from accurately estimating and canceling phase noise.

### SUMMARY

Some aspects described herein relate to an apparatus for wireless communication at a user equipment (UE). The apparatus may include one or more memories storing processor-executable code and one or more processors coupled with the one or more memories. At least one processor of the one or more processors may be configured to cause the UE to receive an indication of a plurality of candidate phase tracking reference signal (PTRS) frequency resources. At least one processor of the one or more processors may be configured to cause the UE to transmit an indication of one or more selected PTRS frequency resources of the plurality of candidate PTRS frequency resources. At least one processor of the one or more processors may be configured to cause the UE to receive a PTRS in accordance with the indication of the one or more selected PTRS frequency resources.

Some aspects described herein relate to an apparatus for wireless communication at a network node. The apparatus may include one or more memories storing processor-executable code and one or more processors coupled with the one or more memories. At least one processor of the one or more processors may be configured to cause the network node to transmit an indication of a plurality of candidate PTRS frequency resources. At least one processor of the one or more processors may be configured to cause the network node to receive an indication of one or more selected PTRS frequency resources of the plurality of candidate PTRS frequency resources. At least one processor of the one or more processors may be configured to cause the network node to transmit a PTRS in accordance with the indication of the one or more selected PTRS frequency resources.

Some aspects described herein relate to a method of wireless communication performed at a UE. The method may include receiving an indication of a plurality of candidate PTRS frequency resources. The method may include transmitting an indication of one or more selected PTRS frequency resources of the plurality of candidate PTRS frequency resources. The method may include receiving a PTRS in accordance with the indication of the one or more selected PTRS frequency resources.

Some aspects described herein relate to a method of wireless communication performed at a network node. The method may include transmitting an indication of a plurality of candidate PTRS frequency resources. The method may include receiving an indication of one or more selected PTRS frequency resources of the plurality of candidate PTRS frequency resources. The method may include transmitting a PTRS in accordance with the indication of the one or more selected PTRS frequency resources.

Some aspects described herein relate to an apparatus for wireless communication. The apparatus may include means for receiving an indication of a plurality of candidate PTRS frequency resources. The apparatus may include means for transmitting an indication of one or more selected PTRS frequency resources of the plurality of candidate PTRS frequency resources. The apparatus may include means for receiving a PTRS in accordance with the indication of the one or more selected PTRS frequency resources.

Some aspects described herein relate to an apparatus for wireless communication. The apparatus may include means for transmitting an indication of a plurality of candidate PTRS frequency resources. The apparatus may include means for receiving an indication of one or more selected PTRS frequency resources of the plurality of candidate PTRS frequency resources. The apparatus may include means for transmitting a PTRS in accordance with the indication of the one or more selected PTRS frequency resources.

Some aspects described herein relate to a non-transitory computer-readable medium storing a set of instructions for wireless communication. The set of instructions may include one or more instructions that, when executed at a UE, cause the UE to receive an indication of a plurality of candidate PTRS frequency resources. The set of instructions may include one or more instructions that, when executed at the UE, cause the UE to transmit an indication of one or more selected PTRS frequency resources of the plurality of candidate PTRS frequency resources. The set of instructions may include one or more instructions that, when executed at the UE, cause the UE to receive a PTRS in accordance with the indication of the one or more selected PTRS frequency resources.

Some aspects described herein relate to a non-transitory computer-readable medium storing a set of instructions for wireless communication. The set of instructions may include one or more instructions that, when executed at a network node, cause the network node to transmit an indication of a plurality of candidate PTRS frequency resources. The set of instructions may include one or more instructions that, when executed at the network node, cause the network node to receive an indication of one or more selected PTRS frequency resources of the plurality of candidate PTRS frequency resources. The set of instructions may include one or more instructions that, when executed at the network node, cause the network node to transmit a PTRS in accordance with the indication of the one or more selected PTRS frequency resources.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating examples associated with phase tracking reference signal (PTRS) patterns, in accordance with the present disclosure.

FIG. 3 is a diagram illustrating an example associated with signaling for PTRS resource selection, in accordance with the present disclosure.

FIG. 4 is a diagram illustrating an example associated with time-variable PTRS frequency domain locations, in accordance with the present disclosure.

FIG. 5 is a flowchart illustrating an example process performed, for example, at a user equipment (UE) or an apparatus of a UE that supports PTRS resource selection, in accordance with the present disclosure.

FIG. 6 is a flowchart illustrating an example process performed, for example, at a network node or an apparatus of a network node that supports PTRS resource selection, in accordance with the present disclosure.

FIG. 7 is a diagram of an example apparatus for wireless communication, such as a UE, that supports PTRS resource selection, in accordance with the present disclosure.

FIG. 8 is a diagram of an example apparatus for wireless communication, such as a network node, that supports PTRS resource selection, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Phase noise increases with carrier frequency (for example, phase noise may increase from a sub-6 GHz range, to a millimeter wave (mmWave) range, to a sub-THz range). A phase noise power spectral density (PSD) (which may be referred to as a phase noise mask) characterizes the power of the phase noise at various frequencies, and a sum of the power of the phase noise over the various frequencies is a total phase noise power. The phase noise impairment of a target signal can be modeled as a convolution in the frequency domain between the phase noise mask and the target signal (in the time domain, the phase noise may be multiplicative with the target signal).

A user equipment (UE) may address phase noise for downlink signals. For example, UEs can be designed with sufficiently low phase noise for reception of downlink signals modulated using a quadrature amplitude modulation (QAM) of up to 256-QAM. However, downlink communications may be modulated using high-order (“super-QAM”) modulations, such as 4096-QAM (4K-QAM) or 16,384-QAM (16K-QAM), among other examples. Such high-order modulations may require high operating signal-to-noise ratios (SNRs), which can be limited by phase noise. Thus, phase noise may become a limiting noise floor and thereby prevent implementations of high-order modulations (for example, in high bandwidths).

Accordingly, to help enable implementations of high-order modulations, a UE may suppress phase noise. Because a phase noise mask may extend across all frequencies, the UE may estimate the phase noise by assuming a typical bandwidth of the phase noise spectrum. For example, the UE may estimate the phase noise using a quantity of assumed significant subcarriers such that any residual error is negligible. Because phase noise is random, the UE may estimate the phase noise on a per-symbol basis. In some examples, the UE may receive a phase tracking reference signal (PTRS), estimate the phase noise using the PTRS, and cancel the estimated phase noise. For example, the UE may estimate the phase noise by employing a least squares methodology using PTRS samples.

The quality of the estimation of the phase noise may depend on the quality of the received PTRS waveform. For example, if the PTRS is allocated on one or more low-SNR resource elements (REs) (for example, due to channel fading), then the estimation result is poor, which limits the ability of the UE to perform phase noise suppression and leads to a residual error involving throughput loss. For example, a UE may have multiple channels for respective antennas, and the PTRS may pass through one or more such channels. For example, the PTRS may be propagated via a dispersive high bandwidth channel that includes some frequencies that are highly attenuated or nulled. As a result, the PTRS may have poor SNR, leading to poor phase noise estimation and suppression, and, ultimately, causing failure in the demodulation and decoding of the entire slot. However, being unable to identify residual error requirements of the UE, a network node may allocate the PTRS in such a way that increases phase noise estimation error, does not satisfy residual error requirements of the UE, and fails to enable high order modulation.

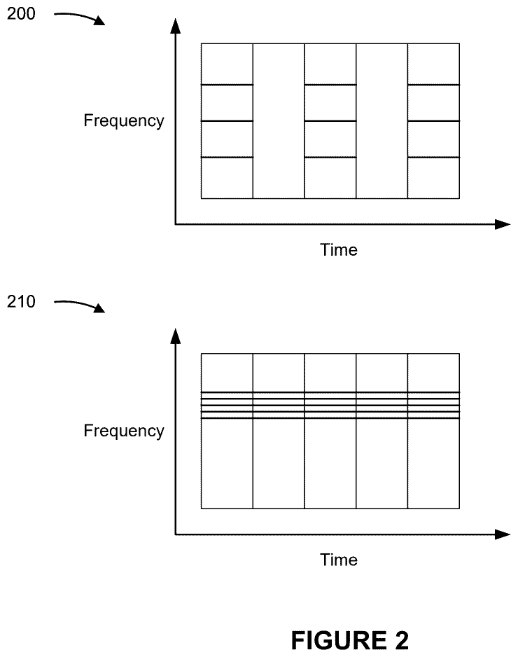

Various aspects relate generally to resource selection for PTRSs. Some aspects more specifically relate to dynamically selecting frequency resources to convey a PTRS. In some aspects, a network node may identify that the UE supports a PTRS that is contiguous over time resources and frequency resources. The network node may inform the UE of possible frequency resources for PTRS allocation. The UE may identify a frequency resource, from among the possible frequency resources, having a corresponding channel that can best support PTRS transmission. The UE may report the frequency resource to the network node, and the network node may transmit the PTRS in accordance with the reported frequency resource. In some examples, the PTRS transmitted by the network node may be contiguous, as discussed in greater detail below in connection with FIG. 2. A contiguous PTRS may occupy consecutive resources elements in the frequency domain and the time domain. For example, the contiguous PTRS may be allocated for every symbol in a slot.

In some aspects, the UE may identify the frequency resource using mean channel gain. For example, the UE may identify the frequency resource that has a highest mean channel gain of all of the mean channel gains of the possible frequency resources.

In some aspects, the UE may identify the frequency resource using minimum channel gain. For example, the UE may identify the frequency resource that has a highest minimum channel gain of all of the minimum channel gains of the possible frequency resources.

In some aspects, the UE may identify the frequency resource using SNR. For example, the UE may identify the frequency resource that has a highest SNR of all of the SNRs of the possible frequency resources.

Particular aspects of the subject matter described in this disclosure can be implemented to realize one or more of the following potential advantages. In some examples, the described techniques can be used to support high order modulation. For example, dynamically varying PTRS allocation in the frequency domain may increase the SNR of the PTRS in the presence of time-variable channel conditions. This increase in SNR may improve phase noise estimation and, thus, phase noise suppression with sufficient accuracy to support high order modulation.

Identifying the frequency resource using mean channel gain may reduce UE processing and/or memory resources that are occupied for identification of frequency resources. For example, the UE may identify the frequency resource having the highest mean channel gain using computationally unintensive operations. In some examples, using mean channel gain may be less computationally intensive than using minimum channel gain.

Identifying the frequency resource using minimum channel gain may reduce UE processing and/or memory resources that are occupied for identification of frequency resources and may improve selection results from among the possible frequency resources in examples where the highest minimum channel gain is sufficient for transmission of the PTRS. For example, the UE may identify the frequency resource having the highest minimum channel gain using computationally unintensive operations and with improved accuracy. In some examples, using minimum channel gain may be more accurate than using mean channel gain and less computationally intensive than using SNR.

Identifying the frequency resource using SNR may improve selection results from among the possible frequency resources. For example, the UE may identify the frequency resource having the highest SNR with improved accuracy. In some examples, using SNR may be more accurate than using minimum channel gain.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

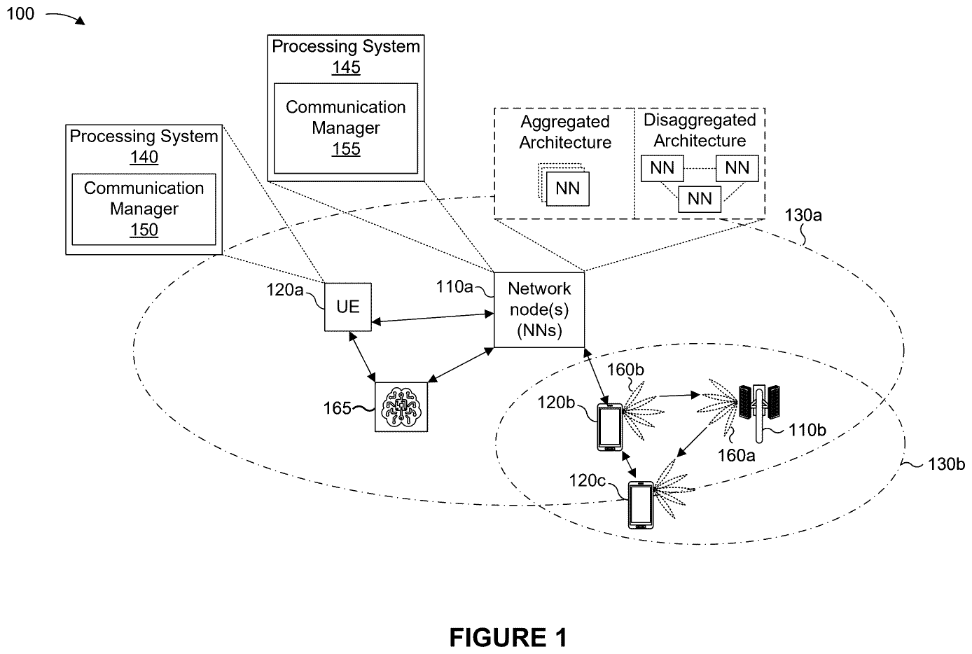

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHZ,” if used herein, may broadly refer to frequencies that are less than 6 GHZ, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and REs), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a PTRS, a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of QAM, such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, one or more network nodes 110, one or more UEs 120, and/or one or more servers, and/or one or more components of a cloud computing network, among other examples). For example, in an deployment where AI/ML functionality is performed independently at a device 165, sometimes referred to as “overlay AI/ML”, the AI/ML model (or an instance or portion of the AI/ML model) may be deployed at a UE 120 (for example, at the processing system 140), a network node 110 (for example, at the processing system 145), one or more servers, and/or one or more components of a cloud computing network, among other examples. Additionally or alternatively, in a deployment where AI/ML functionality is coordinated between different devices 165, sometimes referred to as “coordinated AI/ML”, or performed at all device and network layers, sometimes referred to as “native AI/ML”, the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML and/or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, and/or efficient use of network bandwidth, and/or to reduce latency, among other examples). For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, and/or traffic prediction, among other examples. In some examples, AI-as-a-Service use cases may include measurement collection reporting by a UE 120, device selection criteria (for example, according to a geographical area where measurements are to be collected and/or UE capabilities to be used to collected measurements), and/or reporting configurations (for example, reporting parameters such as location, time, and/or sensor information, among other examples). Additionally or alternatively, the AI/ML model(s) may enable AI/ML procedures (for example, RAN-triggered service establishment, configuration, inferencing using UE-side and/or network-side models, performance monitoring and/or management, and/or capability signaling, among other examples). Additionally or alternatively, the AI/ML model(s) may enable RAN-based AI/ML services via one or more application program interfaces (APIs) and/or management interfaces for use cases such as beam management, radio resource monitoring (RRM) relaxation, mobility prediction, load prediction, network energy savings, and/or coverage and capacity improvements, among other examples.

In some aspects, the UE 120 may include a communication manager 150. As described in more detail elsewhere herein, the communication manager 150 may receive an indication of a plurality of candidate PTRS frequency resources; transmit an indication of one or more selected PTRS frequency resources of the plurality of candidate PTRS frequency resources; and receive a PTRS in accordance with the indication of the one or more selected PTRS frequency resources. Additionally or alternatively, the communication manager 150 may perform one or more other operations described herein.

In some aspects, the network node 110 may include a communication manager 155. As described in more detail elsewhere herein, the communication manager 155 may transmit an indication of a plurality of candidate PTRS frequency resources; receive an indication of one or more selected PTRS frequency resources of the plurality of candidate PTRS frequency resources; and transmit a PTRS in accordance with the indication of the one or more selected PTRS frequency resources. Additionally or alternatively, the communication manager 155 may perform one or more other operations described herein.

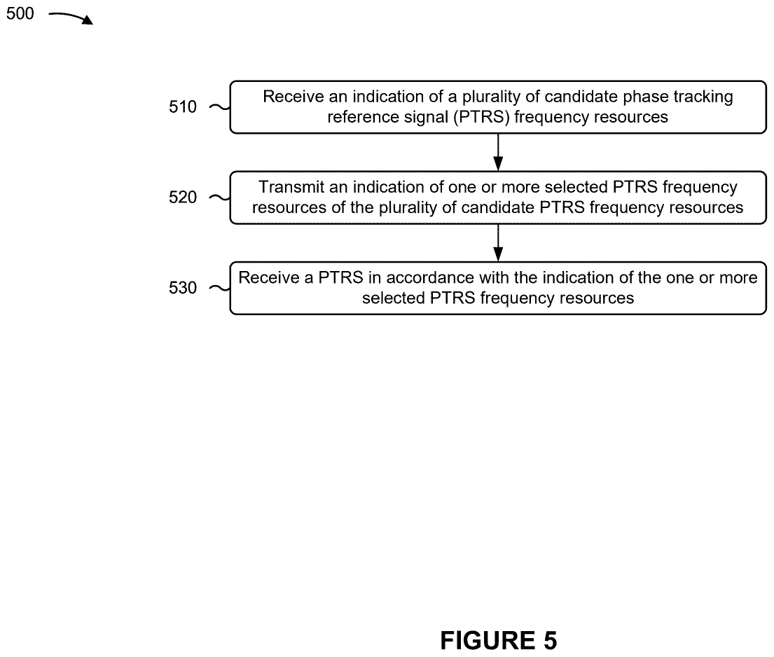

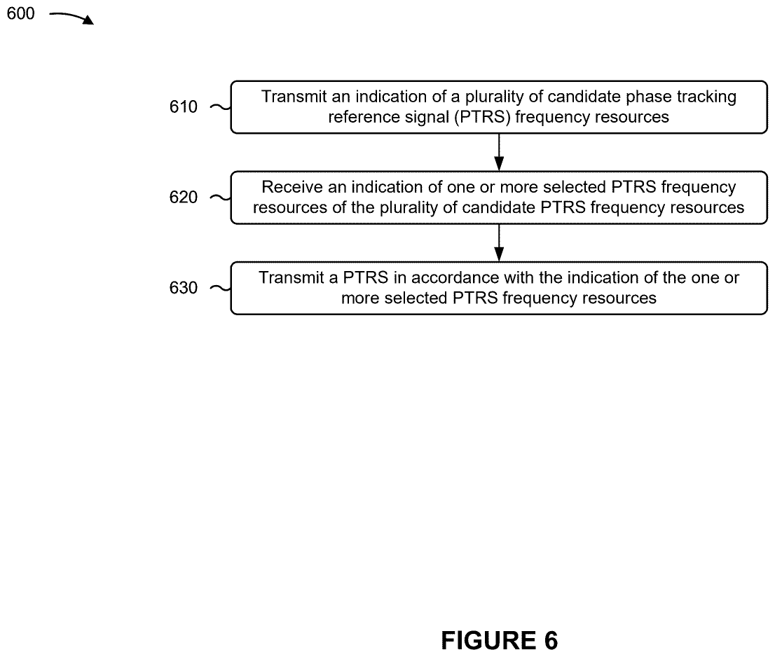

The network node 110, the processing system 145 of the network node 110, the UE 120, the processing system 140 of the UE 120, a CU, a DU, an RU, or any other component(s) of FIG. 1 may implement one or more techniques or perform one or more operations associated with PTRS resource selection, as described in more detail elsewhere herein. For example, the processing system 145 of the network node 110, the processing system 140 of the UE 120, a CU, a DU, and/or an RU may perform or direct operations of, for example, process 500 of FIG. 5, process 600 of FIG. 6, or other processes as described herein (alone or in conjunction with one or more other processors). Memory of the network node 110 may store data and program code (or instructions) for the network node 110, the CU, the DU, or the RU. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, a CU, a DU, and/or an RU, may cause the one or more processors to perform process 500 of FIG. 5, process 600 of FIG. 6, or other processes as described herein. In some examples, executing instructions may include running the instructions, converting the instructions, compiling the instructions, and/or interpreting the instructions, among other examples.

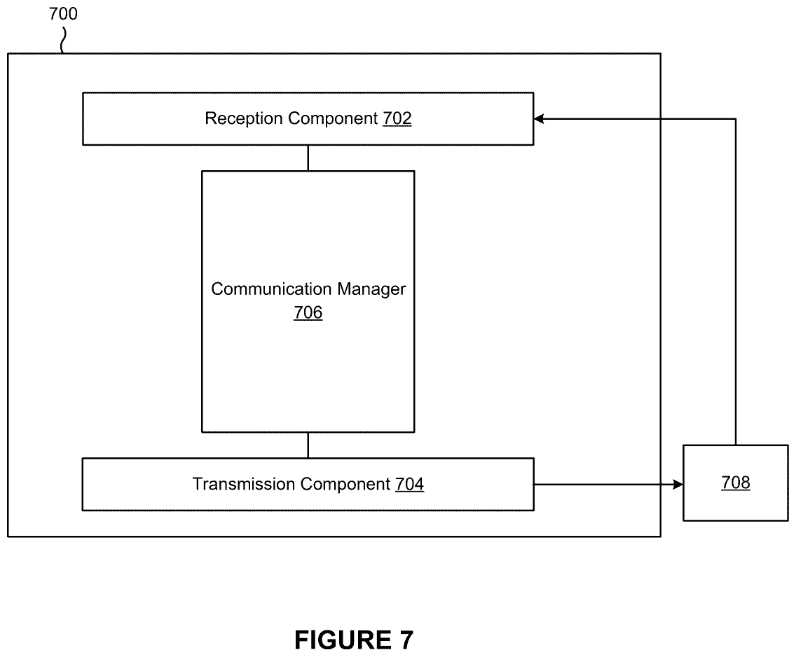

In some aspects, the UE 120 includes means for receiving an indication of a plurality of candidate PTRS frequency resources; means for transmitting an indication of one or more selected PTRS frequency resources of the plurality of candidate PTRS frequency resources; and/or means for receiving a PTRS in accordance with the indication of the one or more selected PTRS frequency resources. The means for the UE 120 to perform operations described herein may include, for example, one or more of communication manager 150, processing system 140, a radio, one or more RF chains, one or more transceivers, one or more antennas, one or more modems, a reception component (for example, reception component 702 depicted and described in connection with FIG. 7), and/or a transmission component (for example, transmission component 704 depicted and described in connection with FIG. 7), among other examples.

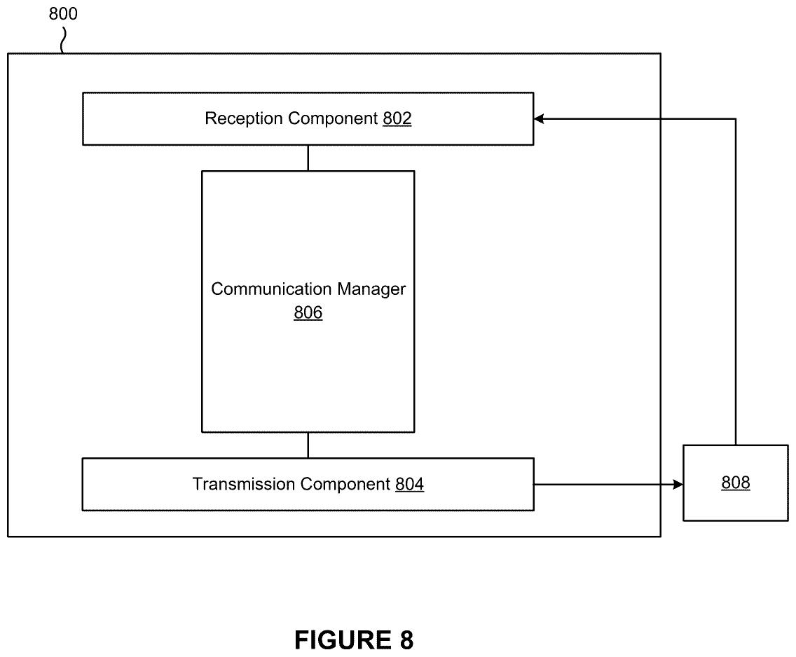

In some aspects, the network node 110 includes means for transmitting an indication of a plurality of candidate PTRS frequency resources; means for receiving an indication of one or more selected PTRS frequency resources of the plurality of candidate PTRS frequency resources; and/or means for transmitting a PTRS in accordance with the indication of the one or more selected PTRS frequency resources. The means for the network node to perform operations described herein may include, for example, one or more of communication manager 155, processing system 145, a radio, one or more RF chains, one or more transceivers, one or more antennas, one or more modems, a reception component (for example, reception component 802 depicted and described in connection with FIG. 8), and/or a transmission component (for example, transmission component 804 depicted and described in connection with FIG. 8), among other examples.

FIG. 2 is a diagram illustrating examples 200 and 210 associated with PTRS patterns, in accordance with the present disclosure.

Example 200 shows a non-contiguous PTRS that has a configured RE density in the frequency domain and/or the time domain. The non-contiguous PTRS may enable cancelation of an average phase noise per symbol (for example, an average constant phase per OFDM symbol, which may be referred to as a common phase error), which may be adequate for low order modulations, such as 256-QAM. However, the non-contiguous PTRS may not enable cancelation of instantaneous phase noise per OFDM symbol. As a result, the non-contiguous PTRS may not enable cancelation of phase noise across an entire assumed phase noise bandwidth, and may not be adequate for high order modulations.

Example 210 shown a contiguous PTRS across multiple resources elements in the frequency domain and the time domain (for example, the PTRS may be allocated for every symbol in a slot). The contiguous PTRS may enable the UE to estimate and cancel the phase noise across an entire assumed phase noise bandwidth as follows. The UE may receive an observed or received signal y(f)=H(f)s(f)*I(f)+w(f), where H(f) is a channel that carried the downlink communication, s(f) is a transmitted signal, I(f) is phase noise in the frequency domain, w(f) is additive white Gaussian noise (AWGN), and “*” is a cyclic convolution operator. First, the UE may perform a channel estimation (H) procedure. Second, by using an assumed phase noise bandwidth (for example, in units of subcarriers) of size U, the UE may derive a transmitted phase noise least squares estimator by realizing the following measurements model:

$$( \begin{matrix}y ( {m}_{start} ) \\ ⋮ \\ ⋮ \\ y ( {m}_{end} )\end{matrix} ) = {\underbrace{( \begin{matrix}\hat{H} s ( {m}_{start} + u + 1 ) & … & \hat{H} s ( {m}_{start} ) 0 & … & 0 \\ ⋮ & & & & ⋮ \\ \hat{H} s ( {m}_{end} ) & & \begin{matrix}⋱\end{matrix} & & 0 \\ 0 & & & & \hat{H} s ( {m}_{start} ) \\ ⋮ & & & & ⋮ \\ 0 & … & 0 \hat{H} s ( {m}_{end} ) & … & \hat{H} s ( {m}_{end} - 2 u )\end{matrix} )}}_{M} ( \begin{matrix}I ( - u ) \\ ⋮ \\ I ( u )\end{matrix} ) + ( \begin{matrix}w ( {m}_{start} ) \\ ⋮ \\ ⋮ \\ w ( {m}_{end} )\end{matrix} )$$

In some examples, [mₛₜₐᵣₜ, m_{end}] is a known symbol interval (for example, a PTRS interval), “ICI” may refer to inter-carrier interference,

$$( \begin{matrix}I ( - u ) \\ ⋮ \\ I ( u )\end{matrix} )$$

may be estimated frequency domain phase noise coefficients, and the assumed phase noise bandwidth may be equal to 2U+1. Thus, the least squares estimator may be represented as I(f)=(M^{H}M)⁻¹M^{H}y(f). Because the channel estimation can be slightly affected by phase noise impairment, an iterative method may be implemented (for example, the UE may perform a first channel estimation, a phase noise impairment estimation using the first channel estimation, and a second channel estimation using the phase noise impairment estimation). Due to the symmetric property of the PSD I(u)=I*(−u), the quantity of parameters may be reduced by 50%.

Upon identifying the estimated frequency domain phase noise coefficients, the UE may perform phase noise correction. In some examples, the UE may perform phase noise correction by subtracting, from the received signal, the convolution result of the estimated frequency domain phase noise coefficients with a reconstructed signal (for example, using pilots and/or hard decision on data). In some examples, the UE may perform phase noise correction by converting the estimated frequency domain phase noise coefficients to the time domain:

$$( \begin{matrix}I ( - u ) \\ ⋮ \\ I ( u )\end{matrix} ) - IFFT$$

(where “IFFT” represents the inverse fast Fourier transform), and then dividing the resulting time domain phase noise coefficients with the time domain received signal. In some examples, the UE may perform phase noise correction by deconvolving the received signal using the inverse version of the estimated frequency domain phase noise coefficients. For example, the UE may identify the inverse version by solving the convolution problem: inverse_version (*) estimated_frequency_domain_phase_noise coefficients=δ[k]. For example, the UE may perform an IFFT on inverse_version and on estimated_frequency_domain_phase_noise to convert those terms to the time domain. The convolution operator may be replaced with a multiplication operator and the δ[k] may be replaced with 1. In this example, the solution may be provided by inverse_version_time_domain=1/estimated_frequency_domain_phase_noise coefficients_time_domain. For example, the UE may perform an FFT on the inverse_version_time_domain, resulting in the inverse_version, which the UE may use to convolve the received signal and remove the ICI. The example implementations discussed above for estimating and canceling phase noise may fit to OFDM waveforms, and other estimation and cancelation implementations may be used for other types of waveforms.

Although the contiguous PTRS may enable the UE to estimate and cancel phase noise, the contiguous PTRS may not provide sufficient estimation results to improve the SNR enough to enable the UE to perform high order modulation. For example, if the contiguous PTRS is allocated on one or more low-SNR REs (for example, due to channel fading), then the UE 120 may be unable to accurately estimate the phase noise mask (and/or the corresponding instantaneous ICI), which limits the ability of the UE to perform phase noise suppression (for example, by canceling ICI effects due to phase noise) and leads to a residual error involving throughput loss. For example, if the contiguous PTRS propagates via frequencies that are highly attenuated or nulled, then the contiguous PTRS may have poor SNR, leading to poor phase noise estimation and suppression, and, ultimately, causing failure in the demodulation and decoding of the entire slot. However, being unable to identify residual error requirements of the UE, a network node may allocate the contiguous PTRS in such a way that increases phase noise estimation error, does not satisfy residual error requirements of the UE, and fails to enable high order modulation. Accordingly, techniques are provided herein that enable the frequency domain location of the contiguous PTRS to vary over time (for example, in accordance with a channel state of the UE), which may improve phase noise estimation, thereby enabling high order modulation.

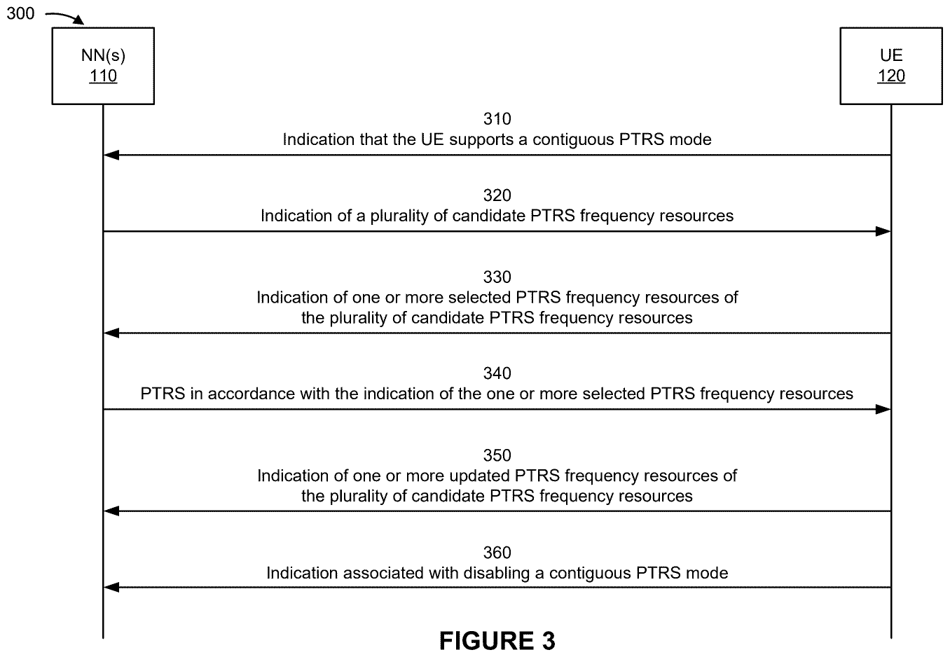

FIG. 3 is a diagram illustrating an example 300 associated with signaling for PTRS resource selection, in accordance with the present disclosure. As shown in FIG. 3, a network node 110 and a UE 120 may communicate with one another.

In a first operation 310, the UE 120 may transmit, and the network node 110 may receive, an indication that the UE 120 supports a contiguous PTRS mode. The contiguous PTRS mode may be a mode of operation in which the UE 120 can decode a contiguous PTRS (example 210, FIG. 2). For example, the network node 110 may identify, using the indication, that the UE 120 is capable of decoding a contiguous PTRS (as opposed to a non-contiguous PTRS (example 200, FIG. 2)). In some examples, the contiguous PTRS mode may be a mode of operation in which the UE 120 can decode one or more contiguous PTRSs having time-variable frequency domain locations. Thus, the UE 120 may share a phase noise suppression capability with the network node 110.

In a second operation 320, the network node 110 may transmit, and the UE 120 may receive, an indication of a plurality of candidate PTRS frequency resources. The candidate PTRS frequency resources may be frequency resources that can be allocated for PTRS transmission. In some examples, the indication may include frequency domain indices corresponding to all possible frequency resources (for example, sub-bands) that can be allocated to the PTRS.

In some aspects, the indication of the plurality of candidate PTRS frequency resources may include an indication of a starting candidate PTRS frequency resource of the plurality of candidate PTRS frequency resources and an ending candidate PTRS frequency resource of the plurality of candidate PTRS frequency resources. The indication may indicate, using the starting candidate PTRS frequency resource and the ending candidate PTRS frequency resource, the plurality of candidate PTRS frequency resources between the starting candidate PTRS frequency resource and the ending candidate PTRS frequency resource, inclusive. For example, the starting candidate PTRS frequency resource may be a starting RE index, and the ending candidate PTRS frequency resource may be an ending RE index.

In some aspects, the indication of the plurality of candidate PTRS frequency resources may include an indication of a starting candidate PTRS frequency resource of the plurality of candidate PTRS frequency resources. For example, the indication may indicate, using the starting candidate PTRS frequency resource and a size of the PTRS (for example, a quantity of candidate PTRS frequency resources) that is already known by the network node 110 and the UE 120, the plurality of candidate PTRS frequency resources beginning with the starting candidate PTRS frequency resource. For example, the starting candidate PTRS frequency resource may be a starting RE index.

In a third operation 330, the UE 120 may transmit, and the network node 110 may receive, an indication of one or more selected PTRS frequency resources of the plurality of candidate PTRS frequency resources. The UE 120 may select a PTRS frequency resource by identifying a channel of each candidate PTRS frequency resource and selecting the candidate PTRS frequency resource that has a highest-quality channel for PTRS transmission. In some examples, the UE 120 may select and report one or more candidate PTRS frequency resources having one or more of the highest-quality channels for PTRS transmission. In some examples, the report may indicate a current channel state of the UE 120. The indication of the one or more selected PTRS frequency resources may be a recommendation for PTRS allocation. For example, the UE 120 may recommend one or more sub-bands for PTRS transmission. In some examples, the recommendation, which may change from slot-to-slot due to channel aging or channel variation, may be conveyed over a PUCCH.

The UE 120 may perform PTRS allocation location selection (for example, the UE 120 may select a candidate PTRS frequency resource) using any suitable implementation. For example, the UE 120 may select of an optimal PTRS sub-band using a metric, such as a metric related to SNR, a metric related to latency, a metric related to any other suitable parameter targeted for optimization. In some examples, the UE may choose a candidate c as c=argmax (Gc), where G, is a metric (for example, a channel quality metric identified by the UE 120) that the UE 120 is targeting for optimization. In some examples, a demodulation latency may depend on the PTRS location in the frequency domain. For example, if the UE 120 extract FFT samples using first in, first out (FIFO) and or last in, first out (LIFO), then the UE 120 may recommend allocating the PTRS at the edges of the spectrum (for example, at the “first” and/or “last” parts of the spectrum). In this example, the UE 120 may optimize latency alone, or optimize latency and SNR jointly.

In some aspects, the UE 120 may transmit, and the network node 110 may receive, the indication of the one or more selected PTRS frequency resources in accordance with a highest mean channel gain of a plurality of mean channel gains associated with the plurality of candidate PTRS frequency resources. The plurality of mean channel gains may be associated with the plurality of candidate PTRS frequency resources in that the plurality of candidate PTRS frequency resources may be estimated to provide the plurality of mean channel gains. In some examples, after performing channel estimation on a channel H, the UE 120 may estimate the mean channel gain of each candidate PTRS frequency resources. The channel H∈C⁴ may have four dimensions: time, frequency, layers (Nₛₛ), and receive antennas (NRX). Thus, in some examples,

$${G}_{c} = {\sum }_{n = 1}^{{N}_{t}} {\sum }_{k = {k}_{c}}^{{k}_{c} + {N}_{k}} {\sum }_{i = 1}^{{N}_{R x}} {\sum }_{j = 1}^{{N}_{s s}} {\vert H ( n , k , i , j ) \vert}^{2} ,$$

where k_{c} and Nₖ represent the starting candidate PTRS frequency resource and the size of the PTRS, respectively, and Nₜ is the quantity of OFDM symbols for which the mean channel gain estimation is performed in the time dimension of the slot. These aspects may be referred to as “direct channel gain.”

In some aspects, the UE 120 may transmit, and the network node 110 may receive, the indication of the one or more selected PTRS frequency resources in accordance with a highest minimum channel gain of a plurality of minimum channel gains associated with the plurality of candidate PTRS frequency resources. The plurality of minimum channel gains may be associated with the plurality of candidate PTRS frequency resources in that the plurality of candidate PTRS frequency resources may be estimated to provide the plurality of minimum channel gains. For example, a “worst” channel (for example, a channel having a minimum channel gain) across layers and receive antennas may be maximized (for example, using a maximum-minimum (max-min) criterion). For example,

$${G}_{c} = min\_over \_i \_j ( {\sum }_{n = 1}^{{N}_{t}} {\sum }_{k = {k}_{c}}^{{k}_{c} + {N}_{k}} {\vert H ( n , k , i , j ) \vert}^{2} ) .$$

These aspects may be referred to as “minimum channel gain.”

In some aspects, the UE 120 may transmit, and the network node 110 may receive, the indication of the one or more selected PTRS frequency resources in accordance with a highest SNR of a plurality of SNRs associated with the plurality of candidate PTRS frequency resources. The plurality of SNRs may be associated with the plurality of candidate PTRS frequency resources in that the plurality of candidate PTRS frequency resources may be estimated to provide the plurality of SNRs. For example, the UE 120 may use the diagonal terms

$${σ}_{k , j}^{2}$$

(representing the noise power of a j-th receive antenna at a frequency k) of an estimated noise covariance matrix Rₙₙ of size NRX by NRx for every RE to calculate an average SNR of a PTRS allocation across receive antennas and across sub-band frequency candidates. For example,

$${G}_{C} = {\sum }_{n = 1}^{{N}_{t}} {\sum }_{k = {k}_{c}}^{{k}_{c} + {N}_{k}} {\sum }_{i = 1}^{{N}_{R x}} {\sum }_{j = 1}^{{N}_{s s}} \frac{{\vert H ( n , k , i , j ) \vert}^{2}}{{σ}_{k , j}^{2}} .$$

These aspects may be referred to as “SNR allocation.”

In a fourth operation 340, the network node 110 may transmit, and the UE 120 may receive, a PTRS in accordance with the indication of the one or more selected PTRS frequency resources. For example, the network node 110 may identify an optimal frequency location for allocation of the PTRS using the indication. For example, the network node 110 may, in identifying a PTRS frequency resource to be allocated for the PTRS, consider the one or more selected PTRS frequency resources as part of a network policy. For example, the network node 110 may allocate the PTRS to a selected PTRS frequency resource as indicated by the UE 120. In some examples, the network node 110 may, before transmitting the PTRS, configure a frequency location of the PTRS in accordance with the indication of the one or more selected PTRS frequency resources.

In a fifth operation 350, the UE 120 may transmit, and the network node 110 may receive, an indication of one or more updated PTRS frequency resources of the plurality of candidate PTRS frequency resources. The UE 120 may select the one or more updated PTRS frequency resources in a similar manner as the UE 120 selected the one or more selected PTRS frequency resources, as described above. The one or more updated PTRS frequency resources may be the same as, or different from, the one or more selected PTRS frequency resources. For example, the indication of one or more updated PTRS frequency resources may be a recommendation of a new frequency location for the PTRS. Thus, the UE 120 may transmit an updated recommendation for PTRS allocation.

In some aspects, the UE 120 may transmit, and the network node 110 may receive, an indication of one or more updated PTRS frequency resources in accordance with a configured periodic time interval. For example, the UE 120 may transmit the indication of one or more updated PTRS frequency resources periodically as dictated by the configured periodic time interval. For example, the UE 120 may transmit the indication of one or more updated PTRS frequency resources every N slots, where N is predetermined by the network node 110.

In some aspects, the UE 120 may transmit, and the network node 110 may receive, an indication of one or more updated PTRS frequency resources responsive to a change in channel conditions. For example, the UE 120 may transmit the indication of one or more updated PTRS frequency resources aperiodically, in accordance with the UE 120 detecting the change in channel conditions. For example, the UE 120 may transmit the indication of one or more updated PTRS frequency resources in response to the change in channel conditions satisfying a channel condition change threshold.

In a sixth operation 360, the UE 120 may transmit, and the network node 110 may receive, an indication associated with disabling the contiguous PTRS mode. The indication may be associated with disabling the contiguous PTRS mode in that the indication may recommend or notify the network node 110 that the contiguous PTRS mode is to be disabled. For example, the UE 120 may transmit the indication due to latency or low-power considerations. In some examples, the indication may be conveyed via UCI.

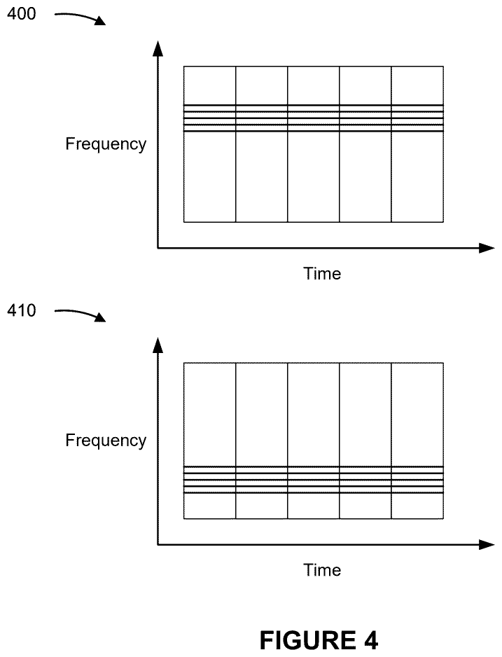

FIG. 4 is a diagram illustrating an example 400 associated with time-variable PTRS frequency domain locations, in accordance with the present disclosure.

Example 400 shows a first contiguous PTRS. The first contiguous PTRS may be contiguous across multiple REs in the frequency domain and the time domain. In some examples, the first contiguous PTRS may be conveyed via one or more frequency resources allocated in accordance with one or more selected PTRS frequency resources as indicated by the UE 120, as discussed above in connection with operations 330 and 340 (FIG. 3).

Example 410 shows a second contiguous PTRS. The second contiguous PTRS may be contiguous across multiple REs in the frequency domain and the time domain. The frequency resources that convey the second contiguous PTRS may be different than the frequency resources that conveyed the first contiguous PTRS. In some examples, the second contiguous PTRS may be conveyed via one or more frequency resources allocated in accordance with one or more updated PTRS frequency resources as indicated by the UE 120, as discussed above in connection with operation 350 (FIG. 3).

The PTRS being transmitted or received in accordance with the indication of the one or more selected PTRS frequency resources may help to support high order modulation. For example, the PTRS allocation in the frequency domain may dynamically and/or adaptively vary, which may increase the SNR of the PTRS in the presence of time-variable channel conditions. This increase in SNR may improve phase noise estimation and, thus, phase noise suppression with sufficient accuracy to support high order modulation. The PTRS waveform may be controlled by allocating frequency domain resources of the PTRS such that residual error in phase noise estimation is reduced or minimized.

The indication of the one or more selected PTRS frequency resources being transmitted or received in accordance with a highest mean channel gain of a plurality of mean channel gains associated with the plurality of candidate PTRS frequency resources may reduce processing and/or memory resources at the UE 120 that are occupied for selecting candidate PTRS frequency resources. For example, identifying a PTRS frequency resource in accordance with the highest mean channel gain may involve computationally unintensive operations at the UE 120. In some examples, identifying a PTRS frequency resource in accordance with the highest mean channel gain may be less computationally intensive than identifying a PTRS frequency resource in accordance with the highest minimum channel gain.

The indication of the one or more selected PTRS frequency resources being transmitted or received in accordance with a highest minimum channel gain of a plurality of minimum channel gains associated with the plurality of candidate PTRS frequency resources may reduce processing and/or memory resources at the UE 120 that are occupied for selecting candidate PTRS frequency resources and may improve selection results from among the candidate PTRS frequency resources in examples where the highest minimum channel gain is sufficient for transmission of the PTRS. For example, identifying a PTRS frequency resource in accordance with the highest minimum channel gain may involve computationally unintensive operations at the UE 120. In some examples, identifying a PTRS frequency resource in accordance with the highest minimum channel gain may yield more accurate selection results than those yielded by identifying a PTRS frequency resource in accordance with the highest mean channel gain. In some examples, identifying a PTRS frequency resource in accordance with the highest minimum channel gain may be less computationally intensive than identifying a PTRS frequency resource in accordance with the highest SNR.

The indication of the one or more selected PTRS frequency resources being transmitted or received in accordance with a highest SNR of a plurality of SNRs associated with the plurality of candidate PTRS frequency resources may improve selection results from among the candidate PTRS frequency resources. For example, identifying a PTRS frequency resource in accordance with the highest SNR may improve an accuracy of the selection results. In some examples, identifying a PTRS frequency resource in accordance with the highest SNR may be more accurate than identifying a PTRS frequency resource in accordance with the minimum channel gain.

FIG. 5 is a flowchart illustrating an example process 500 performed, for example, at a UE or an apparatus of a UE that supports PTRS resource selection, in accordance with the present disclosure. Example process 500 is an example where the apparatus or the UE (for example, UE 120) performs operations associated with PTRS resource selection.

As shown in FIG. 5, in some aspects, process 500 may include receiving an indication of a plurality of candidate PTRS frequency resources (block 510). For example, the UE (such as by using communication manager 150 or reception component 702, depicted in FIG. 7) may receive an indication of a plurality of candidate PTRS frequency resources, as described above in connection with operation 320 (FIG. 3).

As further shown in FIG. 5, in some aspects, process 500 may include transmitting an indication of one or more selected PTRS frequency resources of the plurality of candidate PTRS frequency resources (block 520). For example, the UE (such as by using communication manager 150 or transmission component 704, depicted in FIG. 7) may transmit an indication of one or more selected PTRS frequency resources of the plurality of candidate PTRS frequency resources, as described above in connection with operation 330 (FIG. 3).

As further shown in FIG. 5, in some aspects, process 500 may include receiving a PTRS in accordance with the indication of the one or more selected PTRS frequency resources (block 530). For example, the UE (such as by using communication manager 150 or reception component 702, depicted in FIG. 7) may receive a PTRS in accordance with the indication of the one or more selected PTRS frequency resources, as described above in connection with operation 340 (FIG. 3).

Process 500 may include additional aspects, such as any single aspect or any combination of aspects described below or in connection with one or more other processes described elsewhere herein.

In a first additional aspect, process 500 includes transmitting an indication that the UE supports a contiguous PTRS mode.

In a second additional aspect, alone or in combination with the first aspect, the indication of the plurality of candidate PTRS frequency resources includes an indication of a starting candidate PTRS frequency resource of the plurality of candidate PTRS frequency resources and an ending candidate PTRS frequency resource of the plurality of candidate PTRS frequency resources.

In a third additional aspect, alone or in combination with one or more of the first and second aspects, the indication of the plurality of candidate PTRS frequency resources includes an indication of a starting candidate PTRS frequency resource of the plurality of candidate PTRS frequency resources.

In a fourth additional aspect, alone or in combination with one or more of the first through third aspects, transmitting the indication of the one or more selected PTRS frequency resources includes transmitting the indication of the one or more selected PTRS frequency resources in accordance with a highest mean channel gain of a plurality of mean channel gains associated with the plurality of candidate PTRS frequency resources.

In a fifth additional aspect, alone or in combination with one or more of the first through fourth aspects, transmitting the indication of the one or more selected PTRS frequency resources includes transmitting the indication of the one or more selected PTRS frequency resources in accordance with a highest minimum channel gain of a plurality of minimum channel gains associated with the plurality of candidate PTRS frequency resources.

In a sixth additional aspect, alone or in combination with one or more of the first through fifth aspects, transmitting the indication of the one or more selected PTRS frequency resources includes transmitting the indication of the one or more selected PTRS frequency resources in accordance with a highest SNR of a plurality of SNRs associated with the plurality of candidate PTRS frequency resources.

In a seventh additional aspect, alone or in combination with one or more of the first through sixth aspects, process 500 includes transmitting an indication of one or more updated PTRS frequency resources of the plurality of candidate PTRS frequency resources.

In an eighth additional aspect, alone or in combination with one or more of the first through seventh aspects, transmitting the indication of the one or more updated PTRS frequency resources includes transmitting the indication of the one or more updated PTRS frequency resources in accordance with a configured periodic time interval.

In a ninth additional aspect, alone or in combination with one or more of the first through eighth aspects, transmitting the indication of the one or more updated PTRS frequency resources includes transmitting the indication of the one or more updated PTRS frequency resources responsive to a change in channel conditions.

In a tenth additional aspect, alone or in combination with one or more of the first through ninth aspects, process 500 includes transmitting an indication associated with disabling a contiguous PTRS mode.

Although FIG. 5 shows example blocks of process 500, in some aspects, process 500 may include additional blocks, fewer blocks, different blocks, or differently arranged blocks than those depicted in FIG. 5. Additionally or alternatively, two or more of the blocks of process 500 may be performed in parallel.

FIG. 6 is a flowchart illustrating an example process 600 performed, for example, at a network node or an apparatus of a network node that supports PTRS resource selection, in accordance with the present disclosure. Example process 600 is an example where the apparatus or the network node (for example, network node 110) performs operations associated with PTRS resource selection.

As shown in FIG. 6, in some aspects, process 600 may include transmitting an indication of a plurality of candidate PTRS frequency resources (block 610). For example, the network node (such as by using communication manager 155 or transmission component 804, depicted in FIG. 8) may transmit an indication of a plurality of candidate PTRS frequency resources, as described above in connection with operation 320 (FIG. 3).

As further shown in FIG. 6, in some aspects, process 600 may include receiving an indication of one or more selected PTRS frequency resources of the plurality of candidate PTRS frequency resources (block 620). For example, the network node (such as by using communication manager 155 or reception component 802, depicted in FIG. 8) may receive an indication of one or more selected PTRS frequency resources of the plurality of candidate PTRS frequency resources, as described above in connection with operation 330 (FIG. 3).

As further shown in FIG. 6, in some aspects, process 600 may include transmitting a PTRS in accordance with the indication of the one or more selected PTRS frequency resources (block 630). For example, the network node (such as by using communication manager 155 or transmission component 804, depicted in FIG. 8) may transmit a PTRS in accordance with the indication of the one or more selected PTRS frequency resources, as described above in connection with operation 340 (FIG. 3).

Process 600 may include additional aspects, such as any single aspect or any combination of aspects described below or in connection with one or more other processes described elsewhere herein.

In a first additional aspect, process 600 includes receiving an indication that a UE supports a contiguous PTRS mode.

In a second additional aspect, alone or in combination with the first aspect, the indication of the plurality of candidate PTRS frequency resources includes an indication of a starting candidate PTRS frequency resource of the plurality of candidate PTRS frequency resources and an ending candidate PTRS frequency resource of the plurality of candidate PTRS frequency resources.

In a third additional aspect, alone or in combination with one or more of the first and second aspects, the indication of the plurality of candidate PTRS frequency resources includes an indication of a starting candidate PTRS frequency resource of the plurality of candidate PTRS frequency resources.

In a fourth additional aspect, alone or in combination with one or more of the first through third aspects, receiving the indication of the one or more selected PTRS frequency resources includes receiving the indication of the one or more selected PTRS frequency resources in accordance with a highest mean channel gain of a plurality of mean channel gains corresponding to the plurality of candidate PTRS frequency resources.

In a fifth additional aspect, alone or in combination with one or more of the first through fourth aspects, receiving the indication of the one or more selected PTRS frequency resources includes receiving the indication of the one or more selected PTRS frequency resources in accordance with a highest minimum channel gain of a plurality of minimum channel gains corresponding to the plurality of candidate PTRS frequency resources.

In a sixth additional aspect, alone or in combination with one or more of the first through fifth aspects, receiving the indication of the one or more selected PTRS frequency resources includes receiving the indication of the one or more selected PTRS frequency resources in accordance with a highest SNR of a plurality of SNRs corresponding to the plurality of candidate PTRS frequency resources.

In a seventh additional aspect, alone or in combination with one or more of the first through sixth aspects, process 600 includes receiving an indication of one or more updated PTRS frequency resources of the plurality of candidate PTRS frequency resources.

In an eighth additional aspect, alone or in combination with one or more of the first through seventh aspects, receiving the indication of the one or more updated PTRS frequency resources includes receiving the indication of the one or more updated PTRS frequency resources in accordance with a configured periodic time interval.

In a ninth additional aspect, alone or in combination with one or more of the first through eighth aspects, receiving the indication of the one or more updated PTRS frequency resources includes receiving the indication of the one or more updated PTRS frequency resources responsive to a change in channel conditions.

In a tenth additional aspect, alone or in combination with one or more of the first through ninth aspects, process 600 includes receiving an indication associated with disabling a contiguous PTRS mode.

Although FIG. 6 shows example blocks of process 600, in some aspects, process 600 may include additional blocks, fewer blocks, different blocks, or differently arranged blocks than those depicted in FIG. 6. Additionally or alternatively, two or more of the blocks of process 600 may be performed in parallel.

FIG. 7 is a diagram of an example apparatus 700 for wireless communication that supports PTRS resource selection, in accordance with the present disclosure. The apparatus 700 may be a UE, or a UE may include the apparatus 700. In some aspects, the apparatus 700 includes a reception component 702, a transmission component 704, and a communication manager 706, which may be in communication with one another (for example, via one or more buses). As shown, the apparatus 700 may communicate with another apparatus 708 (such as a UE 120, a network node 110, or another wireless communication device) using the reception component 702 and the transmission component 704. The communication manager 706 may be included in, or implemented via, a processing system (for example, the processing system 140). In some aspects, the communication manager 706 is the communication manager 150.

In some aspects, the apparatus 700 may be configured to and/or operable to perform one or more operations described herein in connection with FIGS. 3 and 4. Additionally or alternatively, the apparatus 700 may be configured to and/or operable to perform one or more processes described herein, such as process 500 of FIG. 5.

The reception component 702 may receive communications, such as reference signals, control information, and/or data communications, from the apparatus 708. The reception component 702 may provide received communications to one or more other components of the apparatus 700, such as the communication manager 706. In some aspects, the reception component 702 may perform signal processing on the received communications, and may provide the processed signals to the one or more other components in a similar manner as described above in connection with FIG. 1. In some aspects, the reception component 702 may include one or more components of the UE described above in connection with FIG. 1, such as a radio, one or more RF chains, one or more transceivers, or one or more modems, each of which may in turn be coupled with one or more antennas of the UE.

The transmission component 704 may transmit communications, such as reference signals, control information, and/or data communications, to the apparatus 708. In some aspects, the communication manager 706 may generate communications and may transmit the generated communications to the transmission component 704 for transmission to the apparatus 708. In some aspects, the transmission component 704 may perform signal processing on the generated communications, and may transmit the processed signals to the apparatus 708 in a similar manner as described above in connection with FIG. 1. In some aspects, the transmission component 704 may include one or more components of the UE described above in connection with FIG. 1, such as a radio, one or more RF chains, one or more transceivers, or one or more modems, each of which may in turn be coupled with one or more antennas of the UE. In some aspects, the transmission component 704 may be co-located with the reception component 702.

The communication manager 706 may receive or may cause the reception component 702 to receive an indication of a plurality of candidate PTRS frequency resources. The communication manager 706 may transmit or may cause the transmission component 704 to transmit an indication of one or more selected PTRS frequency resources of the plurality of candidate PTRS frequency resources. The communication manager 706 may receive or may cause the reception component 702 to receive a PTRS in accordance with the indication of the one or more selected PTRS frequency resources. In some aspects, the communication manager 706 may perform one or more operations described elsewhere herein as being performed by one or more components of the communication manager 706.

The reception component 702 may receive an indication of a plurality of candidate PTRS frequency resources. The transmission component 704 may transmit an indication of one or more selected PTRS frequency resources of the plurality of candidate PTRS frequency resources. The reception component 702 may receive a PTRS in accordance with the indication of the one or more selected PTRS frequency resources. In some aspects, the transmission component 704 may transmit an indication that the UE supports a contiguous PTRS mode. In some aspects, the transmission component 704 may transmit an indication of one or more updated PTRS frequency resources of the plurality of candidate PTRS frequency resources. In some aspects, the transmission component 704 may transmit an indication associated with disabling a contiguous PTRS mode.

The quantity and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally or alternatively, a set of (one or more) components shown in FIG. 7 may perform one or more functions described as being performed by another set of components shown in FIG. 7.

FIG. 8 is a diagram of an example apparatus 800 for wireless communication that supports PTRS resource selection, in accordance with the present disclosure. The apparatus 800 may be a network node, or a network node may include the apparatus 800. In some aspects, the apparatus 800 includes a reception component 802, a transmission component 804, and a communication manager 806, which may be in communication with one another (for example, via one or more buses). As shown, the apparatus 800 may communicate with another apparatus 808 (such as a UE 120, a network node 110, or another wireless communication device) using the reception component 802 and the transmission component 804. The communication manager 806 may be included in, or implemented via, a processing system (for example, the processing system 145). In some aspects, the communication manager 806 is the communication manager 155.

In some aspects, the apparatus 800 may be configured to and/or operable to perform one or more operations described herein in connection with FIGS. 3 and 4. Additionally or alternatively, the apparatus 800 may be configured to and/or operable to perform one or more processes described herein, such as process 600 of FIG. 6.

The reception component 802 may receive communications, such as reference signals, control information, and/or data communications, from the apparatus 808. The reception component 802 may provide received communications to one or more other components of the apparatus 800, such as the communication manager 806. In some aspects, the reception component 802 may perform signal processing on the received communications, and may provide the processed signals to the one or more other components in a similar manner as described above in connection with FIG. 1. In some aspects, the reception component 802 may include one or more components of the network node described above in connection with FIG. 1, such as a radio, one or more RF chains, one or more transceivers, or one or more modems, each of which may in turn be coupled with one or more antennas of the network node.

The transmission component 804 may transmit communications, such as reference signals, control information, and/or data communications, to the apparatus 808. In some aspects, the communication manager 806 may generate communications and may transmit the generated communications to the transmission component 804 for transmission to the apparatus 808. In some aspects, the transmission component 804 may perform signal processing on the generated communications, and may transmit the processed signals to the apparatus 808 in a similar manner as described above in connection with FIG. 1. In some aspects, the transmission component 804 may include one or more components of the network node described above in connection with FIG. 1, such as a radio, one or more RF chains, one or more transceivers, or one or more modems, each of which may in turn be coupled with one or more antennas of the network node. In some aspects, the transmission component 804 may be co-located with the reception component 802.

The communication manager 806 may transmit or may cause the transmission component 804 to transmit an indication of a plurality of candidate PTRS frequency resources. The communication manager 806 may receive or may cause the reception component 802 to receive an indication of one or more selected PTRS frequency resources of the plurality of candidate PTRS frequency resources. The communication manager 806 may transmit or may cause the transmission component 804 to transmit a PTRS in accordance with the indication of the one or more selected PTRS frequency resources. In some aspects, the communication manager 806 may perform one or more operations described elsewhere herein as being performed by one or more components of the communication manager 806.

The transmission component 804 may transmit an indication of a plurality of candidate PTRS frequency resources. The reception component 802 may receive an indication of one or more selected PTRS frequency resources of the plurality of candidate PTRS frequency resources. The transmission component 804 may transmit a PTRS in accordance with the indication of the one or more selected PTRS frequency resources. In some aspects, the reception component 802 may receive an indication that a UE supports a contiguous PTRS mode. In some aspects, the reception component 802 may receive an indication of one or more updated PTRS frequency resources of the plurality of candidate PTRS frequency resources. In some aspects, the reception component 802 may receive an indication associated with disabling a contiguous PTRS mode.

The quantity and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed at a user equipment (UE), comprising: receiving an indication of a plurality of candidate phase tracking reference signal (PTRS) frequency resources; transmitting an indication of one or more selected PTRS frequency resources of the plurality of candidate PTRS frequency resources; and receiving a PTRS in accordance with the indication of the one or more selected PTRS frequency resources.

Aspect 2: The method of Aspect 1, further comprising: transmitting an indication that the UE supports a contiguous PTRS mode.

Aspect 3: The method of any of Aspects 1-2, wherein the indication of the plurality of candidate PTRS frequency resources includes an indication of a starting candidate PTRS frequency resource of the plurality of candidate PTRS frequency resources and an ending candidate PTRS frequency resource of the plurality of candidate PTRS frequency resources.

Aspect 4: The method of any of Aspects 1-3, wherein the indication of the plurality of candidate PTRS frequency resources includes an indication of a starting candidate PTRS frequency resource of the plurality of candidate PTRS frequency resources.

Aspect 5: The method of any of Aspects 1-4, wherein transmitting the indication of the one or more selected PTRS frequency resources includes transmitting the indication of the one or more selected PTRS frequency resources in accordance with a highest mean channel gain of a plurality of mean channel gains associated with the plurality of candidate PTRS frequency resources.

Aspect 6: The method of any of Aspects 1-5, wherein transmitting the indication of the one or more selected PTRS frequency resources includes transmitting the indication of the one or more selected PTRS frequency resources in accordance with a highest minimum channel gain of a plurality of minimum channel gains associated with the plurality of candidate PTRS frequency resources.

Aspect 7: The method of any of Aspects 1-6, wherein transmitting the indication of the one or more selected PTRS frequency resources includes transmitting the indication of the one or more selected PTRS frequency resources in accordance with a highest signal-to-noise ratio (SNR) of a plurality of SNRs associated with the plurality of candidate PTRS frequency resources.

Aspect 8: The method of any of Aspects 1-7, further comprising: transmitting an indication of one or more updated PTRS frequency resources of the plurality of candidate PTRS frequency resources.

Aspect 9: The method of Aspect 8, wherein transmitting the indication of the one or more updated PTRS frequency resources includes transmitting the indication of the one or more updated PTRS frequency resources in accordance with a configured periodic time interval.

Aspect 10: The method of Aspect 8, wherein transmitting the indication of the one or more updated PTRS frequency resources includes transmitting the indication of the one or more updated PTRS frequency resources responsive to a change in channel conditions.

Aspect 11: The method of any of Aspects 1-10, further comprising: transmitting an indication associated with disabling a contiguous PTRS mode.

Aspect 12: A method of wireless communication performed at a network node, comprising: transmitting an indication of a plurality of candidate phase tracking reference signal (PTRS) frequency resources; receiving an indication of one or more selected PTRS frequency resources of the plurality of candidate PTRS frequency resources; and transmitting a PTRS in accordance with the indication of the one or more selected PTRS frequency resources.

Aspect 13: The method of Aspect 12, further comprising: receiving an indication that a user equipment (UE) supports a contiguous PTRS mode.

Aspect 14: The method of any of Aspects 12-13, wherein the indication of the plurality of candidate PTRS frequency resources includes an indication of a starting candidate PTRS frequency resource of the plurality of candidate PTRS frequency resources and an ending candidate PTRS frequency resource of the plurality of candidate PTRS frequency resources.

Aspect 15: The method of any of Aspects 12-14, wherein the indication of the plurality of candidate PTRS frequency resources includes an indication of a starting candidate PTRS frequency resource of the plurality of candidate PTRS frequency resources.

Aspect 16: The method of any of Aspects 12-15, wherein receiving the indication of the one or more selected PTRS frequency resources includes receiving the indication of the one or more selected PTRS frequency resources in accordance with a highest mean channel gain of a plurality of mean channel gains corresponding to the plurality of candidate PTRS frequency resources.

Aspect 17: The method of any of Aspects 12-16, wherein receiving the indication of the one or more selected PTRS frequency resources includes receiving the indication of the one or more selected PTRS frequency resources in accordance with a highest minimum channel gain of a plurality of minimum channel gains corresponding to the plurality of candidate PTRS frequency resources.

Aspect 18: The method of any of Aspects 12-17, wherein receiving the indication of the one or more selected PTRS frequency resources includes receiving the indication of the one or more selected PTRS frequency resources in accordance with a highest signal-to-noise ratio (SNR) of a plurality of SNRs corresponding to the plurality of candidate PTRS frequency resources.

Aspect 19: The method of any of Aspects 12-18, further comprising: receiving an indication of one or more updated PTRS frequency resources of the plurality of candidate PTRS frequency resources.

Aspect 20: The method of Aspect 19, wherein receiving the indication of the one or more updated PTRS frequency resources includes receiving the indication of the one or more updated PTRS frequency resources in accordance with a configured periodic time interval.

Aspect 21: The method of Aspect 19, wherein receiving the indication of the one or more updated PTRS frequency resources includes receiving the indication of the one or more updated PTRS frequency resources responsive to a change in channel conditions.

Aspect 22: The method of any of Aspects 12-21, further comprising: receiving an indication associated with disabling a contiguous PTRS mode.

Aspect 23: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-22.

Aspect 24: An apparatus for wireless communication at a device, the apparatus comprising one or more memories and one or more processors coupled to the one or more memories, the one or more processors configured to cause the device to perform the method of one or more of Aspects 1-22.

Aspect 25: An apparatus for wireless communication, the apparatus comprising at least one means for performing the method of one or more of Aspects 1-22.

Aspect 26: A non-transitory computer-readable medium storing code for wireless communication, the code comprising instructions executable by one or more processors to perform the method of one or more of Aspects 1-22.

Aspect 27: A non-transitory computer-readable medium storing a set of instructions for wireless communication, the set of instructions comprising one or more instructions that, when executed by one or more processors of a device, cause the device to perform the method of one or more of Aspects 1-22.

Aspect 28: A device for wireless communication, the device comprising a processing system that includes one or more processors and one or more memories coupled with the one or more processors, the processing system configured to cause the device to perform the method of one or more of Aspects 1-22.

Aspect 29: An apparatus for wireless communication at a device, the apparatus comprising one or more memories and one or more processors coupled to the one or more memories, the one or more processors individually or collectively configured to cause the device to perform the method of one or more of Aspects 1-22.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories storing processor-executable code; and
one or more processors coupled with the one or more memories, at least one processor of the one or more processors configured to cause the UE to:
receive an indication of a plurality of candidate phase tracking reference signal (PTRS) frequency resources;
transmit an indication of one or more selected PTRS frequency resources of the plurality of candidate PTRS frequency resources; and
receive a PTRS in accordance with the indication of the one or more selected PTRS frequency resources.

2. The apparatus of claim 1, wherein at least one processor of the one or more processors is configured to cause the UE to:
transmit an indication that the UE supports a contiguous PTRS mode.

3. The apparatus of claim 1, wherein the indication of the plurality of candidate PTRS frequency resources includes an indication of a starting candidate PTRS frequency resource of the plurality of candidate PTRS frequency resources and an ending candidate PTRS frequency resource of the plurality of candidate PTRS frequency resources.

4. The apparatus of claim 1, wherein the indication of the plurality of candidate PTRS frequency resources includes an indication of a starting candidate PTRS frequency resource of the plurality of candidate PTRS frequency resources.

5. The apparatus of claim 1, wherein the at least one processor, to cause the UE to transmit the indication of the one or more selected PTRS frequency resources, is configured to cause the UE to transmit the indication of the one or more selected PTRS frequency resources in accordance with a highest mean channel gain of a plurality of mean channel gains associated with the plurality of candidate PTRS frequency resources.

6. The apparatus of claim 1, wherein the at least one processor, to cause the UE to transmit the indication of the one or more selected PTRS frequency resources, is configured to cause the UE to transmit the indication of the one or more selected PTRS frequency resources in accordance with a highest minimum channel gain of a plurality of minimum channel gains associated with the plurality of candidate PTRS frequency resources.

7. The apparatus of claim 1, wherein the at least one processor, to cause the UE to transmit the indication of the one or more selected PTRS frequency resources, is configured to cause the UE to transmit the indication of the one or more selected PTRS frequency resources in accordance with a highest signal-to-noise ratio (SNR) of a plurality of SNRs associated with the plurality of candidate PTRS frequency resources.

8. The apparatus of claim 1, wherein at least one processor of the one or more processors is configured to cause the UE to:
transmit an indication of one or more updated PTRS frequency resources of the plurality of candidate PTRS frequency resources.

9. The apparatus of claim 8, wherein the at least one processor, to cause the UE to transmit the indication of the one or more updated PTRS frequency resources, is configured to cause the UE to transmit the indication of the one or more updated PTRS frequency resources in accordance with a configured periodic time interval.

10. The apparatus of claim 8, wherein the at least one processor, to cause the UE to transmit the indication of the one or more updated PTRS frequency resources, is configured to cause the UE to transmit the indication of the one or more updated PTRS frequency resources responsive to a change in channel conditions.

11. The apparatus of claim 1, wherein at least one processor of the one or more processors is configured to cause the UE to:
transmit an indication associated with disabling a contiguous PTRS mode.

12. An apparatus for wireless communication at a network node, comprising:
one or more memories storing processor-executable code; and
one or more processors coupled with the one or more memories, at least one processor of the one or more processors configured to cause the network node to:
transmit an indication of a plurality of candidate phase tracking reference signal (PTRS) frequency resources;
receive an indication of one or more selected PTRS frequency resources of the plurality of candidate PTRS frequency resources; and
transmit a PTRS in accordance with the indication of the one or more selected PTRS frequency resources.

13. The apparatus of claim 12, wherein at least one processor of the one or more processors is configured to cause the network node to:
receive an indication that a user equipment (UE) supports a contiguous PTRS mode.

14. The apparatus of claim 12, wherein the indication of the plurality of candidate PTRS frequency resources includes an indication of a starting candidate PTRS frequency resource of the plurality of candidate PTRS frequency resources and an ending candidate PTRS frequency resource of the plurality of candidate PTRS frequency resources.

15. The apparatus of claim 12, wherein the indication of the plurality of candidate PTRS frequency resources includes an indication of a starting candidate PTRS frequency resource of the plurality of candidate PTRS frequency resources.

16. The apparatus of claim 12, wherein the at least one processor, to cause the network node to receive the indication of the one or more selected PTRS frequency resources, is configured to cause the network node to receive the indication of the one or more selected PTRS frequency resources in accordance with a highest mean channel gain of a plurality of mean channel gains corresponding to the plurality of candidate PTRS frequency resources.

17. The apparatus of claim 12, wherein the at least one processor, to cause the network node to receive the indication of the one or more selected PTRS frequency resources, is configured to cause the network node to receive the indication of the one or more selected PTRS frequency resources in accordance with a highest minimum channel gain of a plurality of minimum channel gains corresponding to the plurality of candidate PTRS frequency resources.

18. The apparatus of claim 12, wherein the at least one processor, to cause the network node to receive the indication of the one or more selected PTRS frequency resources, is configured to cause the network node to receive the indication of the one or more selected PTRS frequency resources in accordance with a highest signal-to-noise ratio (SNR) of a plurality of SNRs corresponding to the plurality of candidate PTRS frequency resources.

19. The apparatus of claim 12, wherein at least one processor of the one or more processors is further configured to cause the network node to:
receive an indication of one or more updated PTRS frequency resources of the plurality of candidate PTRS frequency resources.

20. The apparatus of claim 19, wherein the at least one processor, to cause the network node to receive the indication of the one or more updated PTRS frequency resources, is configured to cause the network node to receive the indication of the one or more updated PTRS frequency resources in accordance with a configured periodic time interval.

21. The apparatus of claim 19, wherein the at least one processor, to cause the network node to receive the indication of the one or more updated PTRS frequency resources, is configured to cause the network node to receive the indication of the one or more updated PTRS frequency resources responsive to a change in channel conditions.

22. The apparatus of claim 12, wherein at least one processor of the one or more processors is further configured to cause the network node to:
receive an indication associated with disabling a contiguous PTRS mode.

23. A method of wireless communication performed at a user equipment (UE), comprising:
receiving an indication of a plurality of candidate phase tracking reference signal (PTRS) frequency resources;
transmitting an indication of one or more selected PTRS frequency resources of the plurality of candidate PTRS frequency resources; and
receiving a PTRS in accordance with the indication of the one or more selected PTRS frequency resources.

24. The method of claim 23, further comprising:
transmitting an indication that the UE supports a contiguous PTRS mode.

25. The method of claim 23, wherein the indication of the plurality of candidate PTRS frequency resources includes an indication of a starting candidate PTRS frequency resource of the plurality of candidate PTRS frequency resources and an ending candidate PTRS frequency resource of the plurality of candidate PTRS frequency resources.

26. The method of claim 23, wherein the indication of the plurality of candidate PTRS frequency resources includes an indication of a starting candidate PTRS frequency resource of the plurality of candidate PTRS frequency resources.

27. A method of wireless communication performed at a network node, comprising:
transmitting an indication of a plurality of candidate phase tracking reference signal (PTRS) frequency resources;
receiving an indication of one or more selected PTRS frequency resources of the plurality of candidate PTRS frequency resources; and
transmitting a PTRS in accordance with the indication of the one or more selected PTRS frequency resources.

28. The method of claim 27, further comprising:
receiving an indication of one or more updated PTRS frequency resources of the plurality of candidate PTRS frequency resources.

29. The method of claim 28, wherein receiving the indication of the one or more updated PTRS frequency resources includes receiving the indication of the one or more updated PTRS frequency resources in accordance with a configured periodic time interval.

30. The method of claim 28, wherein receiving the indication of the one or more updated PTRS frequency resources includes receiving the indication of the one or more updated PTRS frequency resources responsive to a change in channel conditions.
